(19) United States
(12) Patent Application Publication
(10) Pub. No.: US 2006/0044946 A1
(43) Pub. Date: Mar. 2, 2006

(54) Processing sheme for domain expansion rom media

(75) Inventor: Gavin Nicholas Phillips, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,917

(22) PCT Filed: Oct. 7, 2003
(86) PCT No.: PCT/IB03/04443

§ 371 Date: Apr. 27, 2005

(30) Foreign Application Priority Data
Nov. 1, 2002 (EP) 02079590.

(51) Int. Cl. G11B 11/00

(52) U.S. Cl. 369/13.09; 369/13.01

(57) ABSTRACT

The present invention relates to a domain expansion storage medium and processing method for processing a storage medium to obtain an improved readout performance. The magnetic properties of a storage layer (50) of the storage medium are altered by an ion beam projection lithography using a stencil mask to define magnetic domains and/or track patterns and/or servo patterns. Thereby, replication accuracy, speed and readout performance can be improved.

The present invention relates to a read-only domain expansion storage media and a processing scheme for processing a storage layer of such media in which a magnetic wall is displaced to thereby enlarge a magnetic domain so as to reproduce information indicated by the magnetic domain.

In magneto-optical storage systems, the minimum width of the recorded marks is determined by the diffraction limit, i.e. by the Numerical Aperture (NA) of the focussing lens and the laser wavelength. A reduction of the width is generally based on shorter wavelength lasers and higher NA focussing optics. The capability of writing extremely small domains is essential to increasing a real storage densities in magneto-optical (MO) media Domain expansion media typically consist of a polycarbonate substrate, a reflective heat conducting layer, a first dielectric layer, a magnetically hard e.g. TbFeCo storage layer which is coupled either magnetostatically through a second dielectric layer or directly via exchange coupling through intermediate magnetic layers to a magnetically soft e.g. GdFeCo read-out layer, a third dielectric layer and/or an acrylic resin cover layer. Data storage is achieved by using a thermomagnetic writing technique whereby the thin storage layer having a thickness of about 20 nm is heated to the Curie temperature by a focussed laser or other radiation spot, and then allowed to cool down in the presence of a magnetic field. The heated area is thereby “frozen” with a magnetic orientation parallel to that of the magnetic field. Fortunately, writing is a thermal process which is not limited to the spot size of the laser, but rather to the size of the heated area Currently, the ability to write small domains far exceeds the ability to read them. Writing is achieved by modulating either the laser power, e.g. in Light Intensity Modulation (LIM), the external field, e.g. in Magnetic Field Modulation (MFM), or both, e.g. in Laser Pumped MFM (LP-MFM). Data retrieval is achieved via domain expansion whereby a domain written in the storage layer is copied to the read-out layer where it expands to fill the optical read-out spot.

MAMMOS (Magnetic AMplifyng Magneto-Optical System) is a domain expansion method based on magneto-statically coupled storage and readout layers, wherein magnetic field modulation is used for expansion and collapse of expanded domains in the readout layer. A written mark from the storage layer with high coercivity is copied to the readout layer with low coercivity, upon laser heating with the help of an external magnetic field. Due to the low coercivity of this readout layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs. Therefore, no signal will be detected in this case.

Domain Wall Displacement Detection (DWDD) is another DomEx method based on an exchange-coupled storage and readout layer, proposed by T. Shiratori et al. in Proc. MORIS'97, J. Magn. Soc. Jpn., 1998, Vol. 22, Supplement No. S2, pp. 47-50. In a DWDD medium, marks recorded in the storage layer are transferred to a displacement layer via an intermediate switching layer as a result of exchange coupling forces. The temperature rises when reproducing laser spots are irradiated onto the discs recording tracks. When the switching layer exceeds the Curie temperature, the magnetization is lost, causing the exchange coupling force between each layer to disappear. The exchange coupling force is one of the forces holding the transferred marks in the displacement layer. When it disappears, the domain wall surrounding the recorded marks shifts to a high temperature section which has low domain wall energy, allowing small recorded marks to expand. The domain wall which had been transferred into the displacement layer shifts as if being pulled by a rubber band. This allows reading via laser beam, even if recordings have been made at high density.

Domain expansion techniques such as MAMMOS and DWDD thus allow readout of bits much smaller than the size of the optical spot, but with a signal much larger than in MSR. The various disk stacks always comprise a recording layer and a readout layer, which may be coupled magneto-statically or by means of exchange coupling. RF MAMMOS requires a modulating external magnetic field during readout, which increases the power consumption, but also allows readout at very high densities and with large signals. Alternative techniques like ZF MAMMOS and DWDD require no external magnetic field during readout, but are expected to be limited to somewhat lower densities, smaller signals and lower data rates.

Present domain expansion technology is restricted to re-writable disks. However, a ROM domain expansion solution by which data cannot be freely written to the domain expansion medium or disk does not exist. In families of optical storage media, the ROM (Read Only Memory) format is seen as an addition used for cheap and fast reproduction of pre-recorded data. These properties of ROM are considered essential for the success of an optical storage product-family. In the case of domain expansion media, a ROM solution is not trivial. The reason is that data is defined by magnetization directions in the storage layer, which are not easily reproduced in pre-recorded media, e.g. by injection moulding.

Documents U.S. Pat. No. 5,993,937 and EP 0848381A2 disclose domain expansion ROM media with a domain expansion stack on an injection moulded substrate with smooth and rough areas to define the recorded information. Both solutions utilize etching through an e-beam mastered resist pattern in order to roughen areas on a glass master or substrate. The master may then be used to produce conventional stampers which are in turn used to produce substrates with roughened areas. The magnetic storage layer will exhibit an enhanced domain wall coercivity in areas where the substrate has been roughened, so that the magnetization in these areas will be more difficult to erase and much harder to overwrite in such a way as to preserve good read-back performance successfully.

One drawback of using the conventional glass master patterning and roughening techniques resides in that stampers are required which are expensive to produce and which have a limited lifetime. Furthermore, as bit sizes decrease to sub-100 nm dimensions, perfect replication of the roughened ROM data pattern will become technically more demanding. Moreover, patterning and roughening of individual substrates by irradiation of resist followed by etching is time consuming due to the serial writing process which may hinder the commercial viability of this technique.

As another drawback, deliberate roughening of the lower layers of a DomEx media stack may lead to a degradation of the domain expansion process in the read-out layer, due to the roughness of the lower layers being transferred to the upper read-out layer and thus locally degrading the magnetic properties of the read-out layer. Furthermore, any excessive increase in the roughness of the stack may also adversely affect the optical properties of the media. Both effects may result in a degradation of the read-out performance.

It is therefore an object of the present invention to provide a more efficient solution for processing domain expansion ROM media so as to obtain an improved read-out performance.

This object is achieved by a processing method as claimed in claim 1 and a domain expansion storage medium as claimed in claim 11.

Accordingly, a high resolution non-contact technique can be used for altering or even removing magnetism at localized areas of the storage layer of domain expansion storage media, to thereby enable improved replication of ROM data patterns, while preventing degradation of upper layer properties caused by conventional surface roughening. During ion beam projection the mask pattern may be reduced, so that the mask feature size can be larger than the required minimum medium feature size.

An additional protection or dielectric layer may be deposited on the storage layer before performing said beam projection step. In this case, better control of the implantation procedure can be allowed.

The controlling step may be used to control the energy of the ions of the ion beam to obtain a predetermined energy level required for altering the magnetic properties of the storage layer.

Additionally, the ion beam projection and controlling steps may be adapted to define a track structure in the readout layer. Thereby, the land/groove track structure of conventional optical media can be replaced by a magnetic track structure. Specifically, the track structure may comprise magnetic and non-magnetic spiral or concentric tracks.

Furthermore, the beam projection and processing steps may be adapted to write embedded servo information or define spiral or-concentric tracks in the storage layer. Consequently, also in this respect, corresponding land/groove structures of conventional optical disks can be dispensed with.

Alternatively, the focus of the at least one ion beam may be controlled so as to alter the magnetic properties of the readout layer or the readout layer in order to define at least one of the data structure, track and servo patterns. Then, a first focus can be used for forming the data structure, while a second focus can be used for forming the servo pattern.

A whole disk can be patterned in one exposure of the ion beam projection and processing steps. Thereby, individual data, track and/or servo patterns can be written simultaneously in a short processing time.

The mask may be formed by an e-beam lithography and a subsequent semiconductor etching.

Further advantageous modifications are defined in the dependent claims.

In the following, the present invention will be described in greater detail on the basis of preferred embodiments with reference to the accompanying drawings, in which:

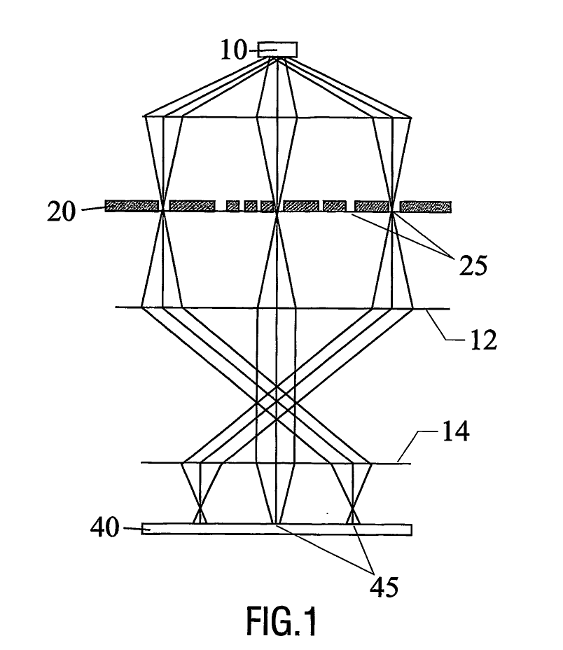

FIG. 1 shows a schematic diagram of an ion beam projection lithography arrangement which can be used for the present invention;

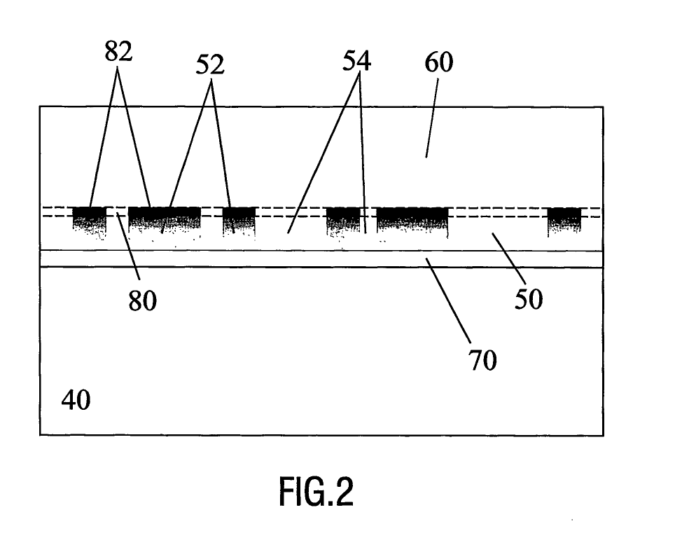

FIG. 2 shows a sectional view of a layer arrangement of a domain expansion storage medium according to the preferred embodiment of the present invention; and

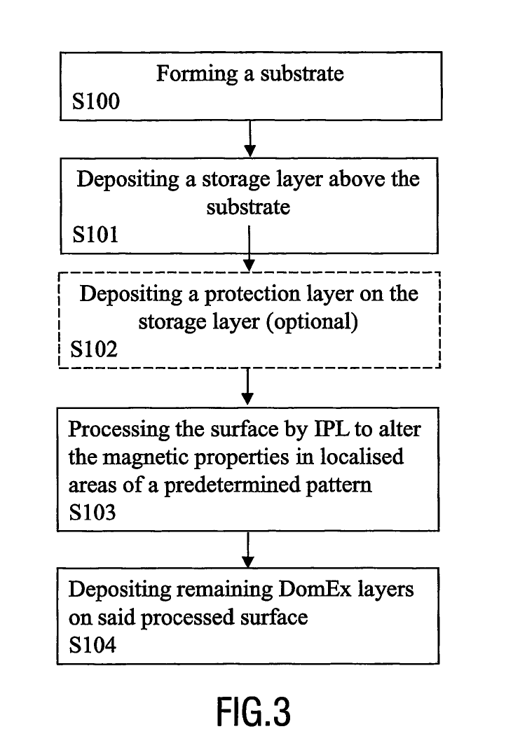

FIG. 3 shows a schematic flow diagram of a substrate processing method according to the preferred embodiment of the present invention.

The preferred embodiments will now be described on the basis of a domain expansion ROM disc, wherein the magnetic properties of the storage layer are selectively altered during manufacturing by using an ion beam projection lithography (IPL).

FIG. 1 schematically illustrates an ion beam projection lithography (IPL) arrangement or tool. In general, such an IPL tool is used for the formation of an image of a structured mask or stencil mask 20, i.e. a mask provided with openings 25 for passing a beam of ions, upon a substrate 40 of the domain expansion ROM disk and comprises an ion source 10 for generating the ion beam, the structured stencil mask 20 and an immersion lens 14 between the stencil mask 20 and the substrate 40. The immersion lens 14 serves to accelerate the ions to the desired final energy for structuring the substrate 40. Furthermore, a prelens 12 and a projection lens 16 can be provided also in the path of the ion beam. On the substrate 40, a demagnified pattern 45 can be obtained at a size depending on the projection parameters. The ion source 10 may be a helium (He) ion source for generating desired He ions. Further details of the IPL tool can be gathered from Kaesmaier et al., SPE conference on Microlithography, Santa Clara, Calif. (2000).

According to the preferred embodiments, ion beam projection lithography (IPL) provides an alternative high resolution modification and/or patterning technique for controlling the magnetic properties of the storage layer of the DomEx layer stack generated on the substrate 40. If ions with the correct energy or momentum are used, then it is possible for the magnetic properties of a thin film, i.e. the storage layer, to be altered, or even removed, over very localized areas due to the implantation of ions, or atoms from any protective layers previously deposited onto the storage layer. Subsequent deposition of the remaining layers, e.g. readout layer etc., of the MAMMOS stack on this modified or patterned storage layer will result in a DomEx ROM disk.

FIG. 2 shows a sectional view of a layer structure of the domain expansion ROM disk according to the preferred embodiment. In general, the magneto-optical recording medium or disk for realizing super-resolution or domain expansion reading may be composed of any magnetic layer or film differing in the coercive force depending on the recorded information and possessing a relatively large magneto-optical effect. The recording information is expressed by the coercivity of the concerned magnetic layer. Hence, depending on the recording information, when a rare earth—transition metal (RE-TM) alloy magnetic storage layer 50 is formed on the substrate 40 and subsequently exposed to ion beam irradiation through a mask, a magneto-optical recording medium possessing portions differing in the coercive force depending on the recording information is obtained. In FIG. 2, portions 52 with low coercivity are shown below ion beam exposed areas 82 of an optional protective or dielectric layer 80 which has been deposited on the storage layer 50 before ion beam exposure. The remaining portions are magnetic portions 54 with high coercivity. The storage layer 50 is covered by exchange, readout and dielectric layers 60 to form the required DomEx layer stack.

The portions 52 that are located below the ion beam exposed areas 82 may possess lower or higher coercivity, or lower or higher magnetization than the remaining portions 54, or may lose their magnetic properties completely, depending on the dose, i.e. ions per square centimeter, and energy of the ions used during exposure.

The optional protective or dielectric layer 80 is first deposited on the storage layer 50 and then exposed by using IPL to implant atoms from the protective or dielectric layer 80 into the storage layer 50 to thereby alter the magnetic properties of the storage layer 50 below exposed areas of the protective or dielectric layer 80. If no such protective or dielectric layer 80 is deposited, the ions of the projected ion beam can be directly implanted into the storage layer 50 to alter its magnetic properties at exposed areas.

Below the storage layer 50, additional underlayers 70, comprising e.g. a seed metal or dielectric layer etc., are deposited on the substrate 40. This additional seed layer 70 allow for greater control of the surface structure of the storage layer 50.

In the preferred embodiment, it may also be possible to use the IPL to modify the magnetic properties of the upper readout layer in order to define tracks, thus removing the need for a land/groove structure in the substrate 40. Exposure of the readout layer in an appropriate way can be used to pattern magnetic and non-magnetic spiral or concentric tracks. Track servoing may then be performed by the low frequency monitoring of the Kerr rotation of the light reflected from the disk during readout.

Alternatively, in the preferred embodiment, IPL may be used to write embedded servo information into the storage layer 50, also allowing the land/groove structure of conventional optical disks to be dispensed with.

Focussed ion beam equipment may also be used to modify the magnetic properties of thin films, such as the storage layer 50 or the readout layer, in order to form ROM data, servo patterns and/or track patterns. However, the use of a single focussed ion beam that has to move across the whole substrate surface may take a prohibitively large amount of time and therefore be commercially unattractive.

The advantage of IPL is that it is a high resolution non-contact technique. Therefore, the perfect replication of ROM data patterns should be considerably eased. Furthermore, a whole small format disk may be patterned in one exposure with the individual data, track and/or servo patterns being written simultaneously in a number of seconds. The aim is to take advantage of the 300 mm wafer throughput of up to 50 wafers per hour, or more, at the 50 nm lithography node (i.e. resolution in terms of half pitches and feature sizes), over stitched 12.5 mm×12.5 mm fields. Assuming that the time required for exchanging and exposing the substrates is under 20 seconds, and that the area to be patterned lies within a 12.5 mm diameter circle, a throughput of 180 discs per hour could be achieved. Larger exposure fields may be accommodated, depending upon the level of pattern distortion at the disk edges that can be tolerated. Alternatively, by using multiple exposures of adjacent areas, larger disks may be patterned at the cost of disc throughput. During the IPL process a 150 mm SOI (Silicon On Insulator) stencil mask 20 pattern can be reduced e.g. by a factor of four during projection onto the substrate. Therefore, the minimum stencil mask 20 feature size may be larger than the required medium minimum feature (bit) size. The stencil mask 20 itself can be manufactured using e-beam lithography and semiconductor etching techniques.

In the following, a method of writing to the storage layer 50 of the domain expansion ROM disk is described with reference to the flow diagram of FIG. 3. According to FIG. 3, in step S100, the substrate 40 is first formed while use can be made, for example, of glass, polycarbonate, polymethyl methacrylate, resin of a thermoplastic origin, or the like. Then, after the underlayers 70 have been deposited on the substrate 40, the storage layer 50 is deposited on the layer stack above the substrate 40 in step S101. In the optional step S102, which can be omitted and is therefore indicated as dotted box in FIG. 3, the additional protective or dielectric layer 80 which may serve as a source of atoms to be implanted into the storage layer 50 upon exposure by IPL, can be deposited on the storage layer 50. in the following step S103, the surface of the protective or dielectric layer 80 or the surface of the storage layer 50, respectively, are processed by IPL to alter the magnetic properties in localized areas of the predetermined pattern defined by the stencil mask 20 of FIG. 1. Thereby, domain portions and/or servo patterns are defined in the storage layer 50. Finally, in step S104, the remaining layer stack of the DomEx ROM disk is formed or deposited on the processed storage layer 50 and the optional protective or dielectric layer 80. If a magnetic track pattern is formed in the readout layer, an additional IPL exposure step can be provided after the deposition of the readout layer and an optional additional protective or dielectric layer.

The magnetic storage layer 50 and the magnetic readout layer may be composed of any RE-TM compound having relatively high magneto-optical effects, such as TbFe, GdTbFe, TbFeCo, DyFe, GdDyFe, DyFeCo, GdDyFeCo, and NdTbFeCo, or a transition metal oxide and nitride compound film, a ferrite film, or a 3D transition metal magnetic film, including multilayers of such films.

The present invention can be applied to any domain expansion ROM medium, while the ion beam processing can be adapted in any suitable way to obtain desired magnetic properties sufficient to define the proposed domain portions, track and/or servo patterns in the storage layer 50 and readout layer, respectively. The preferred embodiment may thus vary within the scope of the attached claims.

1. A method of processing a domain expansion storage medium in which a magnetic wall is displaced in a readout layer to thereby enlarge a magnetic domain of a storage layer so as to reproduce an information indicated by said magnetic domain, said method comprising the steps of:
a) depositing said storage layer above a substrate of said storage medium;
b) passing at least one beam of ions through a mask with a predetermined pattern so as to project said predetermined pattern towards said storage layer; and
c) controlling said ion beam so as to alter the magnetic properties of said storage layer at regions below exposed portions in order to define magnetic domains of a data structure.

2. A method according to claim 1, further comprising the step of depositing an additional protection or dielectric layer on said storage layer before performing said ion beam projection step.

3. A method according to claim 1, wherein the energy of ions of said ion beam is controlled in said controlling step.

4. A method according to claim 1, wherein said ion beam projection and controlling steps are adapted to define a track structure in said readout layer.

5. A method according to claim 4, wherein said track structure comprises magnetic and non-magnetic spiral or concentric tracks.

6. A method according to claim 1, wherein said beam projection and controlling step are adapted to write embedded servo information or spiral or concentric track structure into said storage layer.

7. A method according to claim 1, wherein said controlling step is adapted to control the focus of said at least one ion beam so as to modify the magnetic properties of said storage layer or said readout layer in order to define at least one of data, servo and track patterns.

8. A method according to claim 7, wherein a first focus is used for forming said data structure, while a second focus is used for forming said servo pattern or track patterns.

9. A method according to claim 1, wherein a whole disk is patterned in one or more exposure of said ion beam projection and processing steps.

10. A method according to claim 1, further comprising the step of forming said mask by an e-beam lithography and a subsequent semiconductor etching.

11. A domain expansion storage medium in which a magnetic wall is displaced in a readout layer to thereby enlarge a magnetic domain of a storage layer so as to reproduce the information indicated by said magnetic domain, said storage medium comprising a storage layer processed by selective implantation of ions or atoms with a predetermined pattern to define at least one of a data pattern, a track pattern and a servo pattern.

12. A storage medium according to claim 11, wherein a protection or dielectric layer is deposited on said storage layer of said storage medium.
